(19) United States
(12) Patent Application Publication
(10) Pub. No.: US 2003/0093589 A1
(43) Pub. Date: May 15, 2003

(54) Peripheral device of personal computer and method for initializing the same

(76) Inventors: Cheng-Yuan Wu, Chiai (TW); Tse Hsien Wang, Taoyuan (TW); Benjamin Ym Pan, Taipei (TW); Hui-Lin Chou, Taipei (TW); Chih Hsien Weng, Miaoli (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/213,342

(22) Filed: Aug. 6, 2002

(30) Foreign Application Priority Data
Nov. 14, 2001 (TW) 090128249

(51) Int. Cl. G06F 3/00

(52) U.S. Cl. 710/10

(57) ABSTRACT

A method for initializing an add-on card of a computer and a control chip capable of coupling with the add-on card is provided, wherein the chip has thereon a shadow register, the add-on card has thereon a configuration read-only memory. The method includes steps of loading basic configuration data stored in the configuration read-only memory and required for the operation of the chip to the chip, and storing the basic configuration data in the shadow register when a basic input/output system (BIOS) performs a configuration-data reading action from the configuration read-only memory, and initializing the chip in response to the basic configuration data.

### FIELD OF THE INVENTION

The present invention relates to a peripheral device of a personal computer and a method for initializing the device.

### BACKGROUND OF THE INVENTION

FIG. 1 is a schematic diagram illustrating the relation between a network chip 10 and a non-volatile memory 11, for example, both of which are mounted on a motherboard. The non-volatile memory 11, for example an electrically erasable programmable read-only memory (EEPROM), stores the basic configuration data of the network chip 10, such as media access controller (MAC) addresses, required for operating the chip. Whenever the system is booted or woken up from a sleep mode, the network chip 10 has to be initialized by re-loading the basic configuration data from non-volatile memory 11. As known, the data-reloading process occupies much of the overall time period of the wakeup operation. Due to the unavoidable wakeup period resulting from reloading the basic configuration data and the required non-volatile the memory 11, the performance of the personal computer is deteriorated and the cost is increased. Further, the provision of the EEPORM 11 exclusive for the network chip 10 is cost-inefficient.

### SUMMARY OF THE INVENTION

It is an object of the present invention to provide a peripheral device of a personal computer, in which the basic configuration data required to operate a network chip is stored in an existent memory so as to reduce cost.

It is another object of the present invention to provide a method for initializing a peripheral device of a personal computer to inprove the reading speed, in which the basic configuration data required to operate a network chip is stored in the network chip in a sleep mode so as to exempt from the reading operation of the basic configuration data from the external memory in the wakeup mode.

In accordance with an aspect of the present invention, there is provided a method for initializing a chip with a shadow register. The chip communicates with an add-on card which has thereon a configuration read-only memory. The configuration read-only memory stores therein basic configuration data required for the operation of the chip. The method includes steps of loading basic configuration data to the chip, and storing the basic configuration data in the shadow register of the chip when a basic input/output system (BIOS) performs a configuration-data reading action from the configuration read-only memory, and initializing the chip in response to the basic configuration data.

For example, the chip can be a network chip, an IEEE 1394 control chip or a south bridge chip integrating therewith a Media Access Controller (MAC). The chip is typically installed on a motherboard of a computer.

In an embodiment, the basic configuration data is transmitted from the configuration read-only memory to the shadow register via a Peripheral Component Interconnect (PCI) bus.

In an embodiment, the add-on card is an Advanced Communication Riser (ACR) card and inserted into an ACR slot of the computer.

Preferably, the shadow register is a random access memory.

Alternatively, the shadow register includes a plurality of latches or flip-flops.

Preferably, the shadow register is arranged in a suspend well of the chip so that it will keep awake when the peripheral device is in a sleep mode.

Preferably, the method further includes a step of reinitializing the chip by reading the basic configuration data from the shadow register when the chip is switched from a sleep mode to a wakeup mode.

Preferably, the configuration read-only memory is an electrically erasable programmable read-only memory (EEPROM).

Preferably, the configuration-data reading action is performed during a configuration cycle.

In accordance with another aspect of the present invention, the chip has a digital logic portion and a shadow register, and the add-on card has an analog circuit portion for coupling with the digital logic portion of the chip, and a configuration read-only memory storing therein basic configuration data required to operate the chip. When a basic input/output system (BIOS) program performs a configuration-data reading action from the configuration read-only memory, the basic configuration data is loaded and stored into the shadow register of the chip for initializing the chip.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating the initializaion of a network chip according to prior art;

FIG. 2 is a circuit block diagram illustrating the structure of an ACR card; and

FIG. 3 is a functional block diagram illustrating how a network chip is initialized according to a preferred embodiment of the present invention.

### DETAILED DESCRIPTION OF THE PREFERRED EMBODIMENT

Generally, an add-on card, such as an audio card, a VGA card, a network card or other advanced cards, includes an analog circuit portion and a digital logic portion produced by different processes. With the significant improvement of integrated circuit chips, many suppliers are able to integrate a plurality of functions into a single chip. Therefore, it is possible to integrate the digital logic portion of the add-on card into the south bridge chipset, for example, thereby simplifying the manufacturing process of the add-on card. In other words, the digital logic portion of the add-on card is existent in the PC chipset, and the user can purchase a simplified add-on card with an analog circuit portion with much lower cost and install the same tointo an expansion slot of the computer so as to accomplish the function of an add-on card. One of the examples of the simplified add-on card is a Communication Network Riser (CNR) card or an Advanced Communication Riser (ACR) card.

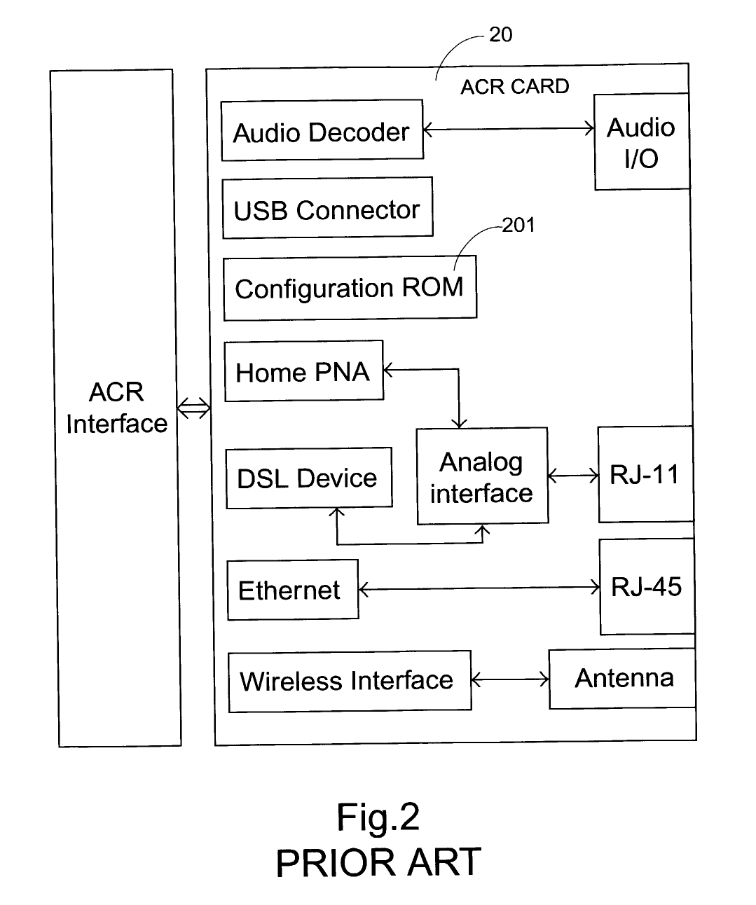

FIG. 2 is a circuit block diagram illustrating an ACR card structure. As shown, the ACR card 20 has thereon a configuration read-only memory (ROM) 201 stored data therein for initializing the associated device. Therefore, under such an ACR card structure, this invention intends to improve the performance and reduce the cost, for example, for the network chip.

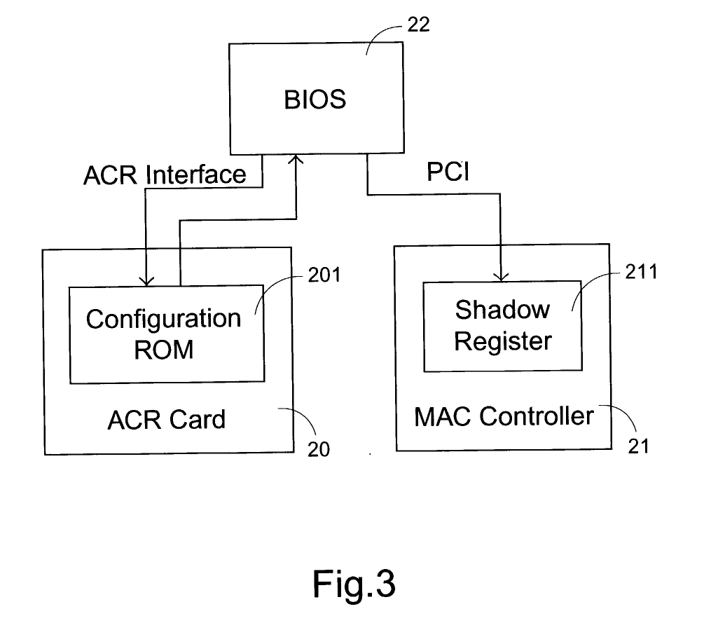

Please refer now to FIG. 3 which is a functional block diagram illustrating how the network chip is initialized according to the present invention. The ACR card 20 is inserted into an expansion slot of a computer so as to communicate with the MAC controller 21 preferably integrated in a south bridge chip on a motherboard of the computer. The MAC controller 21 of the present invention is integrated with a shadow register 211. When the personal computer is powered on, a basic input/output system (BIOS) 22 performs a configuration-data reading cycle from the configuration ROM 201 defined by the ACR specification. Meanwhile, the basic configuration data stored in the configuration ROM 201 is transmitted via a Peripheral Component Interconnect (PCI) bus to the MAC controller 21 and stored in the shadow register 211 of the MAC controller 21. Then, the MAC controller 21 can be initialized according to the basic configuration data. The shadow register 211 of the MAC controller 21 could be implemented, for example, by a plurality of random access memory (RAM) units, latches or flip-flops. This shadow register 211 is preferably arranged in a suspend well of the MAC controller 21. Therefore, when the MAC controller 21 is in a sleep mode, the power for keeping the basic configuration data valid in the shadow register 211 is provided by an auxiliary power. In addition, when the MAC controller 21 is woken up from a sleep mode to a normal mode, the basic configuration data can be quickly retrieved from the shadow register 211 rather than from the configuration ROM 201. Thus the MAC controller 21 is reinitialized efficiently.

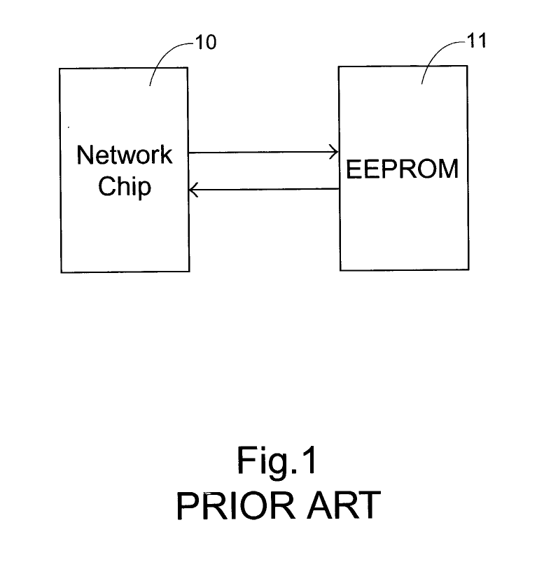

Since the basic configuration data required for the operation of the MAC controller 21 is stored in a configuration ROM 201 of the ACR card, the non-volatile memory 11 (FIG. 1), which is necessary for the prior art, can be reduced. Furthermore, the configuration-data reading action is performed during a configuration cycle, which is faster than the conventional read cycle by the non-volatile memory 11. Because the basic configuration data required to operate the MAC controller 21 is stored in the shadow register 211 even in a sleep mode, re-loading the basic configuration data from the external nonvolatile memory when waking up could be exempted so as to improve the performance for waking up. It should be noted that the shadow register 211 is inherent, and can be enlarged by just using some additional logic gates. Therefore, the present invention will be more cost-effective than the prior art which employs non-volatile memory exclusive for the initialization of the MAC controller 21.

While considering the compatibility of the present arrangement with the prior art, a strip pin or a BIOS flag could be used to choose either of the conventional arrangement of FIG. 1 or the novel arrangement of FIG. 3. The configuration read-only memory 201 is preferably an electrically erasable programmable read-only memory (EEPORM). Furthermore, the present invention is also suitable for an IEEE 1394 control chip, USB control chip or the like.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for initializing a chip with a shadow register, said chip communicating with an add-on card having thereon a configuration read-only memory storing therein basic configuration data required for the operation of said chip, and said method comprising steps of:
loading said basic configuration data to said chip, and storing said basic configuration data in said shadow register of said chip when a basic input/output system (BIOS) performs a configuration-data reading action from said configuration read-only memory; and
initializing said chip in response to said basic configuration data.

2. The method according to claim 1 wherein said chip is installed on a motherboard of said computer.

3. The method according to claim 1 wherein said basic configuration data is transmitted from said configuration read-only memory to said shadow register via a Peripheral Component Interconnect (PCI) bus.

4. The method according to claim 1 wherein said add-on card is an Advanced Communication Riser (ACR) card and inserted into an expansion slot.

5. The method according to claim 1 wherein said shadow register is a random access memory.

6. The method according to claim 1 wherein said shadow register includes a plurality of latches.

7. The method according to claim 1 wherein said shadow register includes a plurality of flip-flops.

8. The method according to claim 1 wherein said shadow register is arranged in a suspend well of said chip.

9. The method according to claim 8 further comprising a step of reinitializing said chip by reading said basic configuration data from said shadow register when said chip is switched from a sleep mode to a wakeup mode.

10. The method according to claim 1 wherein said configuration read-only memory is an electrically erasable programmable read-only memory (EEPROM).

11. The method according to claim 1 wherein said configuration-data reading action is performed during a configuration cycle.

12. The method according to claim 1 wherein said chip is a network chip.

13. The method according to claim 1 wherein said chip is a south bridge chip integrating therewith a Media Access Controller (MAC).

14. A peripheral device of a computer comprising:
a chip having a digital logic portion and a shadow register; and
an add-on card having an analog circuit portion for coupling with said digital logic portion of said chip, and a configuration read-only memory storing therein basic configuration data required to operate said chip, wherein when a basic input/output system (BIOS) program performs a configuration-data reading action from said configuration read-only memory, said basic configuration data is loaded and stored into said shadow register of said chip for initializing said chip.

15. The peripheral device according to claim 14 wherein said chip is selected from a group consisting of a network chip, an IEEE 1394 control chip and a south bridge chip integrating therewith a Media Access Controller (MAC).

16. The peripheral device according to claim 14 wherein said add-on card is an Advanced Communication Riser (ACR) card.

17. The peripheral device according to claim 14 wherein said shadow register is a memory device selected from a group consisting of a random access memory, latches and flip-flops.

18. The peripheral device according to claim 14 wherein said shadow register is arranged in a suspend well of said chip.

19. The peripheral device according to claim 18 wherein when said chip is switched from a sleep mode to a wakeup mode, said basic configuration data stored in said shadow register is read out so as to reinitialize said chip.

20. The peripheral device according to claim 14 wherein said configuration read-only memory is an electrically erasable programmable read-only memory (EEPROM).
